(19) United States
(12) Patent Application Publication
(10) Pub. No.: US 2026/0188262 A1
(43) Pub. Date: Jul. 2, 2026

(54) ELECTROLUMINESCENT DISPLAY DEVICE

(71) Applicant: LG Display Co., Ltd., Seoul (KR)

(72) Inventors: Tae Gung KIM, Paju-si (KR); Jae Yeon SONG, Paju-si (KR)

(73) Assignee: LG Display Co., Ltd., Seoul (KR)

(21) Appl. No.: 19/438,115

(22) Filed: Dec. 31, 2025

(30) Foreign Application Priority Data
Dec. 31, 2024 (KR) 10-2024-0202853

(51) Int. Cl. G09G 3/3275; G09G 3/3233

(52) U.S. Cl. CPC G09G 3/3275; G09G 3/3233; G09G 2300/0465; G09G 2310/0286; G09G 2320/06; G09G 2330/023; G09G 2340/0435; G09G 2370/10

(57) ABSTRACT

An electroluminescent display device can include a display panel in which data lines, sensing lines, and pixels are disposed in a matrix configuration, a data driver including a driver IC configured to supply a data voltage to the data lines, and a timing controller configured to receive pixel data of an input image and a data enable signal synchronized with the pixel data, and transmit the pixel data to the data driver. The driver IC can include a first region in which components driven by a first voltage supplied through an internal power source of the driver IC are mounted, and a second region in which components driven by a second voltage, different from the first voltage and supplied through the internal power source of the driver IC, are mounted.

### CROSS-REFERENCE TO RELATED APPLICATION

This application claims priority to and the benefit of Korean Patent Application No. 10-2024-0202853, filed in the Republic of Korea on December, 31, 2024, the disclosure of which is hereby expressly incorporated by reference in its entirety.

### BACKGROUND

### Technical Field

The present disclosure relates to an electroluminescent display device.

### Discussion of the Related Art

Electroluminescent display devices are broadly classified into inorganic electroluminescent display devices and organic electroluminescent display devices according to the material of the emission layer. An active matrix type organic electroluminescent display device includes a self-emissive light emitting element and has the advantages of a fast response speed, high luminous efficiency, high brightness, and a wide viewing angle. The light emitting element can be an organic light emitting diode (hereinafter referred to as "OLED"). Since the organic electroluminescent display device can express a black gray level as a complete black, it can reproduce images with a superior contrast ratio and color gamut.

The pixels of the organic electroluminescent display device include an OLED and a driving element that drives the OLED by supplying current to the OLED according to a gate-source voltage. The OLED of the organic electroluminescent display device includes an anode, a cathode, and an organic compound layer formed between the anode and the cathode. The organic compound layer is composed of a hole injection layer (HIL), a hole transport layer (HTL), an emission layer (EML), an electron transport layer (ETL), and an electron injection layer (EIL).

When a current flows through the OLED, holes that have passed through the hole transport layer (HTL) and electrons that have passed through the electron transport layer (ETL) move to the emission layer (EML) to form excitons, and as a result, the emission layer (EML) generates visible light.

Recently, there has been an increasing demand for reducing the power consumption in OLEDs (e.g., gaming monitors (MNT)), thereby needing a reduction in circuit power consumption.

For example, in an electroluminescent display device according to the related art, a portion corresponding to the analog voltage SVDD (16.8V) of the D (drive)-IC (integrated circuit) occupies the largest proportion of the circuit power consumption.

To address this issue, OLEDs according to the related art have employed a method of minimizing or reducing power consumption by blocking voltages SVDD and VDD from the outside. For example, OLEDs according to the related art can vary the D-IC applied voltages (SVDD and VDD) to reduce power consumption during a non-driving period, but this can result in a problem of increased cost due to the changes in the circuit configuration needed to vary the SVDD and VDD power. Furthermore, in OLEDs according to the related art, varying the SVDD and VDD power can cause the On sequence to become relatively long (e.g., 100 ms or more), which can result in a problem of limited use cases (e.g., inability to support 60 Hz or variable refresh rate (VRR) driving).

### SUMMARY OF THE DISCLOSURE

An object of the present disclosure is to solve or address the above-described needs and/or other problems and limitations associated with the related art.

An object of the present disclosure is to provide an electroluminescent display device that can minimize or reduce power consumption by entering a low power mode during a period in which an analog voltage in a D-IC is not used when driving an OLED.

Objectives according to embodiments of the present disclosure are not limited to the above-described objectives, and other objectives that are not described herein will be apparently understood by those skilled in the art from the following description.

An electroluminescent display device according to an embodiment of the present disclosure can include a display panel in which data lines, sensing lines, and pixels are disposed in a matrix; a data driver including a driver IC configured to supply a data voltage to the data lines; and a timing controller configured to receive pixel data of an input image and a data enable signal synchronized with the pixel data, and to transmit the pixel data to the data driver, wherein the driver IC includes a first region in which components driven by a first voltage supplied through an internal power source of the driver IC are mounted, and a second region in which components driven by a second voltage, different from the first voltage and supplied through the internal power source of the driver IC, are mounted, wherein, in the first region, a low power mode switch is disposed between the internal power source and the components disposed in the first region, and wherein the low power mode switch is configured to operate, under the control of the timing controller, to provide or cut off the first voltage to the components disposed in the first region.

In addition, according to aspects of the present disclosure, the electroluminescent display device can further include a normal driving mode for displaying the input image on a screen, and a low power mode for driving with low power, wherein the timing controller can analyze, during one frame period (1 Frame Time, 1FT) a video period (Video Time) during which the pixel data of the input image is written to the pixels and a blank period (Blank Time) excluding the video period, and can transition from the normal driving mode to the low power mode when it is determined, based on the analysis result, that high-speed driving or a variable refresh rate (VRR) driving is being performed.

According to aspects of the present disclosure, the components driven by the second voltage can include bus low voltage differential signaling (BLVDS), and when a transition occurs from the normal driving mode to the low power mode, the timing controller can provide a cutoff control signal to the low power mode switch to cut off the first voltage provided to the components disposed in the first region and can cut off the second voltage provided to the BLVDS.

According to aspects of the present disclosure, the timing controller can transmit the cutoff control signal to the low power mode switch using an EPI CTR (Control Packet) during the low power mode.

According to aspects of the present disclosure, digital data (ADC DATA) outputted from an analog-to-digital converter (ADC) can be transmitted to the timing controller through the BLVDS during a transmit period (Transmit Time), and the timing controller can synchronize a timing point of the transmit period with the video period during the low power mode.

According to aspects of the present disclosure, the blank period can include a sensing period for extracting mobility characteristics of a driving element (e.g., driving TFT) by applying a specific voltage to a pixel, and the timing controller can control the transmit period not to overlap with the sensing period.

According to aspects of the present disclosure, when it is determined that variable refresh rate (VRR) driving is being performed, the timing controller can control the transmit period to operate within the video period by changing a timing point of the transmit period according to a driving frequency.

According to aspect of the present disclosure, an electroluminescent display device can include a display panel including data lines, sensing lines, and pixels; a data driver including a driver integrated circuit (IC) configured to supply a data voltage to the data lines; and a timing controller configured to receive pixel data of an input image and a data enable signal synchronized with the pixel data, and transmit the pixel data to the data driver, wherein the driver IC includes a first region and a second region, wherein, in the first region, components driven by a first voltage supplied through an internal power source of the driver IC are disposed, wherein, in the second region, components driven by a second voltage, different from the first voltage and supplied through the internal power source of the driver IC, are disposed, and wherein, in the first region, a low power mode switch is disposed between the internal power source and the components disposed in the first region.

The present disclosure can minimize or reduce power consumption by entering a low power mode during a period in which an analog voltage in a D-IC is not used when driving an OLED.

The effects of the present disclosure are not limited to the effects mentioned above, and other effects not mentioned can be clearly understood by those skilled in the art to which the technical idea of the present disclosure pertains from the following description.

Other systems, methods, features and advantages will be, or will become, apparent to one with skill in the art upon examination of the following drawings and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing general description and the following detailed description are examples and explanatory and are intended to provide further explanation of the inventive concepts as claimed.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram illustrating an electroluminescent display device according to an embodiment of the present disclosure.

FIG. 2 is a circuit diagram illustrating an external compensation circuit connected to a pixel circuit according to an embodiment of the present disclosure.

FIG. 3 is a diagram illustrating a connection relationship between a pixel and a sensing line according to an embodiment of the present disclosure.

FIG. 4 is a diagram illustrating an example in which a sensing block of an external compensation circuit is embedded in a driver IC according to an embodiment of the present disclosure.

FIG. 5 is a diagram illustrating an example of dividing a driver IC into a first region and a second region according to an embodiment of the present disclosure.

FIG. 6 is a diagram illustrating an EPI CTR (control packet) according to an embodiment of the present disclosure.

FIG. 7 is a diagram illustrating transitioning between a normal driving mode and a low power mode according to an embodiment of the present disclosure.

FIG. 8 is a diagram illustrating an operation of a low power mode according to an embodiment of the present disclosure.

FIG. 9 is a diagram illustrating an operation of a low power mode according to another embodiment of the present disclosure.

FIG. 10 is a diagram illustrating a BLVDS according to another embodiment of the present disclosure.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

Reference will now be made in detail to embodiments of the present disclosure, examples of which can be illustrated in the accompanying drawings. In the following description, when a detailed description of well-known functions or configurations related to this document is determined to unnecessarily cloud a gist of the inventive concept, the detailed description thereof will be omitted or can be briefly discussed. The progression of processing steps and/or operations described is an example; however, the sequence of steps and/or operations is not limited to that set forth herein and can be changed as is known in the art, with the exception of steps and/or operations necessarily occurring in a particular order. Like reference numerals designate like elements throughout. Names of the respective elements used in the following explanations can be selected only for convenience of writing the specification and can be thus different from those used in actual products.

Advantages and features of the present disclosure, and methods of accomplishing the same, will become apparent by referring to the embodiments described hereinafter in detail with reference to the accompanying drawings. The present disclosure is not limited to the embodiments disclosed herein but can be embodied in many different forms. Rather, these embodiments are provided so that this disclosure will be thorough and complete, and will fully convey the scope of the disclosure to those skilled in the art. The present disclosure is defined only by the scope of the claims.

The shapes, sizes, ratios, angles, numbers, etc., disclosed in the drawings to illustrate the embodiments of the present disclosure are examples, and the present disclosure is not limited to the matters shown in the drawings. Throughout the specification, the same reference numerals refer to substantially the same constituent elements. Furthermore, in the description of the present disclosure, when it is determined that a detailed description of related known technology can unnecessarily obscure the gist of the present disclosure, the detailed description thereof will be omitted.

Any implementation described herein as an “example” is not necessarily to be construed as preferred or advantageous over other implementations. Further, the term “can” fully encompasses all the meanings and coverages of the term “may” and vice versa.

In this specification, when terms such as "comprising," "including," "having," or "consisting of" are used, other parts can be added unless "only" is used. When an element is expressed in the singular, it can be interpreted as the plural unless explicitly stated otherwise.

In interpreting components, they shall be construed as including error ranges or tolerances, even if not explicitly stated.

When positional relationships and interconnections between two components are described, such as 'on,' 'above,' 'below,' 'beside,' 'connected to,' 'coupled to,' 'crossing,' or 'intersecting,' one or more other components can be interposed between the components, unless terms such as 'directly' or 'immediately' are used.

When a temporal relationship is described using terms such as 'after,' 'subsequent to,' 'next,' or 'before,' the events may not be continuous on the time axis unless 'directly' or 'immediately' is used.

Terms such as 'first,' 'second,' etc. can be used to distinguish components, but these components are not limited in their function or structure by the ordinal numbers or names preceding them.

Further, when an element or layer is “connected,” “coupled,” or “adhered” to another element or layer denotes that the element or layer can not only be directly connected or adhered to another element or layer, but also be indirectly connected or adhered to another element or layer with one or more intervening elements or layers “disposed,” or “interposed” between the elements or layers, unless otherwise specified. It should be understood to mean that elements can be so disposed to directly contact each other, or can be so disposed without directly contacting each other.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning, for example consistent with their meaning in the context of the relevant art and should not be interpreted in an idealized or overly formal sense unless expressly so defined herein. For example, the term such as “part” or “unit” can apply, for example, to a separate circuit or structure, an integrated circuit, a computational block of a circuit device, or any structure configured to perform a described function as should be understood to one of ordinary skill in the art.

Rather, these embodiments of the present disclosure can be provided so that this disclosure can be sufficiently thorough and complete to assist those skilled in the art to fully understand the scope of the present disclosure.

The following embodiments of the present disclosure can be partially or wholly combined or coupled with each other, and various technical interworkings and operations are possible. Each embodiment can be implemented independently of the others, or they can be implemented together in an associated relationship.

In one or more examples, the pixel circuit and the gate driver of the present disclosure can include transistors formed on a substrate of a display panel. The transistors can be implemented as, for example, oxide TFTs (thin film transistors) including an oxide semiconductor, or LTPS TFTs including Low Temperature Poly Silicon (LTPS). In addition, each of the transistors can be implemented as a p-type TFT or an n-type TFT.

A transistor is a three-electrode device including a gate, a source, and a drain. The source of the transistor is an electrode that supplies carriers to the transistor. Within the transistor, carriers begin to flow from the source. The drain is an electrode through which carriers exit the transistor. In a transistor, the flow of carriers is from the source to the drain. In the case of an n-type transistor, since the carriers are electrons, the source voltage is lower than the drain voltage so that electrons can flow from the source to the drain. In an n-type transistor, the direction of current flows from the drain to the source. In the case of a p-type transistor, since the carriers are holes, the source voltage is higher than the drain voltage so that holes can flow from the source to the drain. In a p-type transistor, since holes flow from the source to the drain, the current flows from the source to the drain. It should be noted that the source and drain of a transistor are not fixed. For example, the source and drain of a transistor can be interchanged depending on the applied voltage. Therefore, the disclosure is not limited by the source and drain of the transistor. In the following description, the source and drain of the transistor will be referred to as a first electrode and a second electrode.

A gate signal output from the gate driver swings between a Gate On Voltage and a Gate Off Voltage. The Gate On Voltage is set to a voltage higher than the threshold voltage of the transistor, and the Gate Off Voltage is set to a voltage lower than the threshold voltage of the transistor. The transistor is turned on in response to the Gate On Voltage, whereas it is turned off in response to the Gate Off Voltage. In the case of an n-type transistor, the Gate On Voltage can be a Gate High Voltage (VGH), and the Gate Off Voltage can be a Gate Low Voltage (VGL). In the case of a p-type transistor, the Gate On Voltage can be a Gate Low Voltage (VGL), and the Gate Off Voltage can be a Gate High Voltage (VGH).

Hereinafter, various embodiments of the present disclosure will be described in detail with reference to the accompanying drawings. In the following embodiments, the electroluminescent display device of the present disclosure will be described focusing on an example in which an external compensation circuit is applied. All the components of each display device/apparatus according to all embodiments of the present disclosure are operatively coupled and configured.

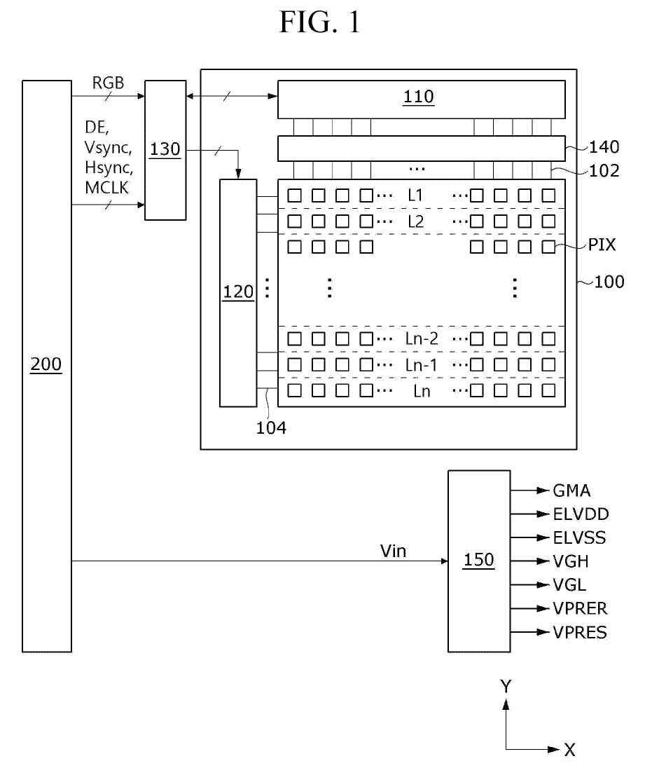

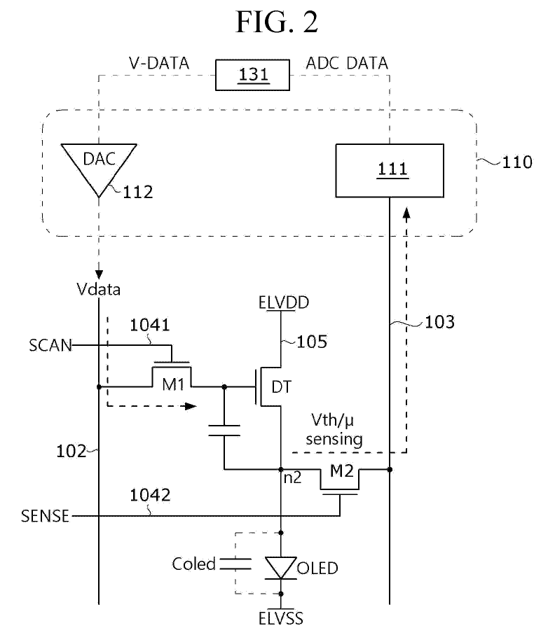

FIG. 1 is a block diagram illustrating an electroluminescent display device according to an embodiment of the present disclosure. FIG. 2 is a circuit diagram illustrating an external compensation circuit connected to a pixel circuit according to an embodiment of the present disclosure.

Referring to FIGS. 1 and 2, the electroluminescent display device according to an embodiment of the present disclosure includes a display panel 100 and a display panel driver.

The electroluminescent display device of the present disclosure can operate in a normal driving mode, in which an input image is displayed on a screen, and a low power mode, in which the device operates at low power during a period in which the analog voltage of the driver IC (D-IC) (or the like) is not used.

In the normal driving mode, the display panel driver can write pixel data of an input image to pixels during an active period (Active Time, AT) under the control of a timing controller 130.

In the low power mode, the display panel driver, under the control of the timing controller 130, can turn off at least one of the unnecessary regions including a D-IC AMP or a bus low voltage differential signaling (BLVDS) between the D-IC and the timing controller during a remaining period excluding the active period (AT) and a sensing period, such that power consumption of the D-IC is minimized or reduced.

The screen of the display panel 100 includes an active area AA (or display area). The active area AA includes a pixel array in which an input image is reproduced. The pixel array includes a plurality of data lines 102, a plurality of gate lines 104 intersecting the data lines 102, and pixels disposed in a matrix.

When the resolution of the pixel array is m×n, the pixel array includes m (where m is a positive integer of 2 or more) pixel columns and n (where n is a positive integer of 2 or more) pixel lines L1 to Ln intersecting the pixel columns. A pixel column includes pixels disposed along a Y-axis direction. A pixel line includes pixels PIX disposed along an X-axis direction. One vertical period is one frame period required to write pixel data corresponding to one frame to all pixels PIX on the screen. One horizontal period is a period required to write pixel data corresponding to one line sharing a gate line to the pixels of one pixel line. One horizontal period is a period obtained by dividing one frame period by m pixel lines L1 to Lm, i.e., the vertical resolution of the display panel 100.

Each of the pixels PIX can be divided into a red sub-pixel R, a green sub-pixel G, and a blue sub-pixel B for color implementation. In another example, each of the pixels can further include a white sub-pixel W. Each of the sub-pixels 101 includes a pixel circuit.

Touch sensors can be disposed on the display panel 100. Touch input can be sensed using separate touch sensors or through the pixels. The touch sensors can be implemented as on-cell type or add-on type sensors disposed on the screen of the display panel, or as in-cell type touch sensors embedded in the pixel array.

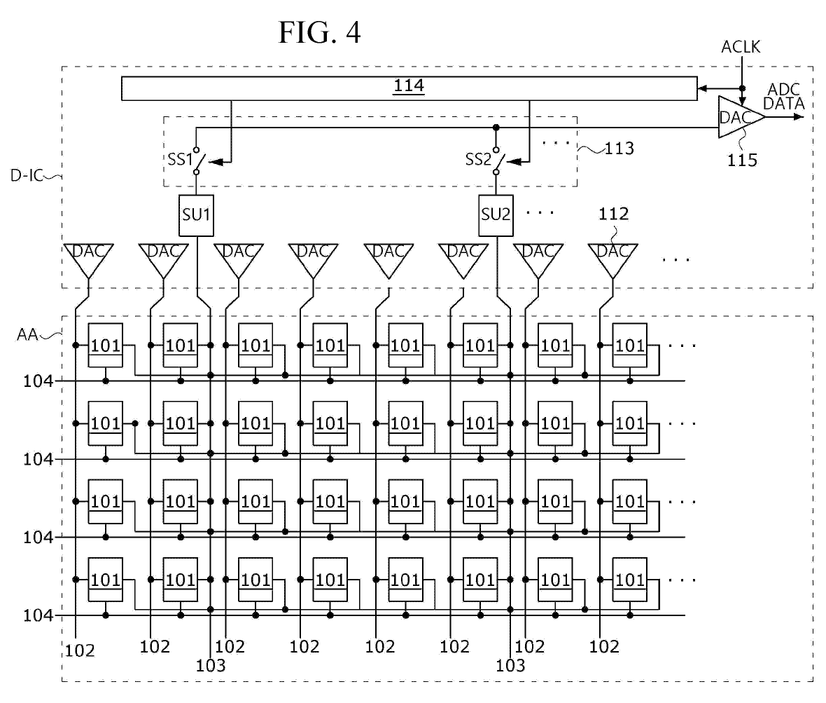

The power supply 150 generates power necessary for driving the pixel array of the display panel 100 and the display panel driver using a DC-to-DC (direct current-to-direct current) converter. The DC-to-DC converter can include a charge pump, a regulator, a buck converter, a boost converter, or the like. The DC-to-DC converter can adjust a DC input voltage Vin from a host system 200 to generate DC powers such as a gamma reference voltage GMA, a gate high voltage VGH, a pixel driving voltage ELVDD, a low potential power voltage ELVSS, and reference voltages VPRER and VPRES. The gamma reference voltage GMA is supplied to a data driver 110. The gate-on voltage VGH and the gate-off voltage VGL are supplied to a gate driver 120. The reference voltages VPRER and VPRES are reference voltages supplied in common to sub-pixels 101 (e.g., see FIG. 4) to uniformly initialize the voltage of a sensing node, i.e., a second node n2, in each of the sub-pixels 101. The power supply 150 can be implemented as a power management integrated circuit (PMIC).

The display panel driver can include the data driver 110 and the gate driver 120, but a variation is possible. A demultiplexer 140 can be disposed between the data driver 110 and the data lines 102. In another example, the demultiplexer 140 can be omitted.

The display panel driver, in the normal driving mode, writes pixel data of an input image to the pixels of the display panel 100 under the control of the timing controller 130 to display the input image on the screen. In mobile devices or wearable devices, the data driver 110, the timing controller 130, and the power supply 150 can be integrated into a single driver integrated circuit (IC).

The data driver 110 receives pixel data RGBW from the timing controller 130. The data driver 110 divides the gamma reference voltage GMA to generate gamma compensation voltages for each gray level of the pixel data, and supplies the gamma compensation voltages to a digital-to-analog converter (hereinafter referred to as "DAC") 112.

The data driver 110 generates a data voltage Vdata by converting pixel data V-DATA into gamma compensation voltages using the DAC 112. The data voltage Vdata outputted from the data driver 110 is supplied to the data lines 102. As will be described below with reference to FIG. 4 described below, the data driver 110 can be implemented as one or more D-ICs.

The data driver 110 can include a sensing block configured to sense a current or a voltage on a sensing node of each of the sub-pixels 101 using a sampling switch element connected to sensing lines 103.

The demultiplexer 140 distributes the data voltage Vdata outputted from the data driver 110 to a plurality of data lines 102 by using switch elements disposed between the data driver 110 and the data lines 102. Since the data voltage Vdata outputted from one channel of the data driver 110 is time-divisionally distributed to a plurality of data lines by the demultiplexer 140, the number of channels of the data driver 110 can be reduced.

The gate driver 120 can be implemented as a gate-in-panel (GIP) circuit directly formed on the display panel 100 together with the pixel array of the active area AA. The GIP circuit can be disposed on the bezel area of the display panel 100 outside the pixel array. The gate driver 120 outputs gate signals to the gate lines 104 under the control of the timing controller 130. The gate driver 120 can sequentially supply the gate signals to the gate lines 104 by shifting the signals using a shift register. The gate signals can include a scan signal SCAN and a sensing signal SENSE, but are not limited thereto. The scan signal SCAN and the sensing signal SENSE can be synchronized to the data voltage Vdata.

The timing controller 130 receives pixel data RGB of an input image and timing signals synchronized with thereto from the host system 200. The timing signals received by the timing controller 130 can include a vertical synchronization signal Vsync, a horizontal synchronization signal Hsync, a main clock MCLK, a data enable signal DE, or the like.

One period of the vertical synchronization signal Vsync corresponds to one frame period. One period of each of the horizontal synchronization signal Hsync and the data enable signal DE corresponds to one horizontal period (1H).

A pulse of the data enable signal DE is synchronized with pixel data of one pixel line to be displayed on the pixels of the active area AA and defines a valid data period. Since the frame period and the horizontal period can be determined by counting the data enable signal DE, the vertical synchronization signal Vsync and the horizontal synchronization signal Hsync can be omitted.

The host system 200 can be any one of a television (TV) system, a set-top box, a navigation system, a personal computer (PC), a home theater system, a mobile device, and a wearable device, but is not limited thereto.

The timing controller 130 can adjust a frame rate to a frequency equal to or greater than an input frame frequency. For example, the timing controller 130 can multiply an input frame frequency by i (i being a positive integer greater than zero) to control the operation timing of the display panel driver at a frame frequency of the input frame frequency × i Hz. The frame frequency is 60 Hz in America national television standards committee (NTSC) system and 50 Hz in a phase-alternating line (PAL) system.

The timing controller 130 generates data timing control signals for controlling the operating timing of the display panel driver based on the timing signals (Vsync, Hsync, CLK, and DE) received from the host system 200, and controls the display panel driver. Since the vertical period and the horizontal period can be determined by counting the data enable signal DE, the vertical synchronization signal Vsync and the horizontal synchronization signal Hsync can be omitted.

A voltage level of a gate timing control signal outputted from the timing controller 130 is converted into the gate high voltage VGH and the gate low voltage VGL through a level shifter and supplied to the gate driver 120.

Referring to FIG. 2, the external compensation circuit includes a sensing line 103 connected to the pixel circuit in each of the sub-pixels 101, a sensing block 111, and a compensation block 131 that receives digital data (ADC DATA) outputted from the sensing block 111. The sensing line 103 is disposed on the screen of the display panel 100 in parallel with the data lines 102. The sensing block 111 senses the electrical characteristics of each of the sub-pixels 101 through the sensing line 103.

The sensing block 111 can be integrated into the integrated circuit (IC) of the data driver 110 together with the DAC 112. The compensation block 131 can be embedded in the timing controller 130.

The external compensation circuit can sense the electrical characteristics of a light emitting element OLED and a driving element DT by initializing the voltage of the sensing line 103 and the source voltage of the driving element DT, i.e., the voltage of the second node n2, to a reference voltage, and then sensing the voltage of the second node n2. The electrical characteristics of the light emitting element OLED and the driving element DT include a threshold voltage Vth and mobility μ.

The sensing block 111 samples a current or a voltage on the sensing line 103 connected to the pixel circuit using an integrator after the normal driving mode. An output voltage of the integrator is inputted to an analog-to-digital converter (hereinafter referred to as "ADC") 115 illustrated in FIG. 4 and converted into the digital data (ADC DATA). The digital data (ADC DATA) outputted from the ADC 115 includes information on the electrical characteristics of each of the sub-pixels 101, for example, information on the threshold voltage Vth and mobility μ of the driving element DT.

A look-up table of the compensation block 131 stores compensation values for compensating for the threshold voltage Vth and the mobility μ of the driving element DT for each sub-pixel. The compensation block 131 inputs sensing data received through the ADC into the look-up table and modulates the pixel data of the input image received from the host system 200 by adding a compensation value outputted from the look-up table to the pixel data, or multiplying the pixel data by the compensation value, thereby compensating for variations in the electrical characteristics of the driving element DT. The compensation value for compensating for the threshold voltage Vth is added to the pixel data. The compensation value for compensating for the mobility μ is multiplied by the pixel data.

The pixel data V-DATA modulated by the compensation block 131 is transmitted to the data driver 110, converted into the data voltage Vdata through the DAC 112 of the data driver 110, and supplied to the data line 102.

As in the example of FIG. 2, the pixel circuit includes the light emitting element OLED, the driving element DT connected to the light emitting element OLED, a plurality of switch TFTs M1 and M2, and a capacitor Cst. The driving element DT and the switch TFTs M1 and M2 can be implemented as n-channel transistors (NMOS), but are not limited thereto.

The light emitting element OLED emits light based on a current generated according to a gate-source voltage Vgs of the driving element DT, which varies depending on the data voltage Vdata. The light emitting element OLED includes an organic compound layer formed between the anode and the cathode. The organic compound layer can include a hole injection layer (HIL), a hole transport layer (HTL), an emission layer (EML), an electron transport layer (ETL), and an electron injection layer (EIL), but is not limited thereto. The anode of the light emitting element OLED is connected to the driving element DT through the second node n2, and the cathode of the light emitting element OLED is connected to an ELVSS electrode to which the low potential power voltage ELVSS is applied. In FIG. 2, "Coled" represents the capacitance of the light emitting element OLED.

The first switch TFT M1 is turned on in response to the gate-on voltage of the scan signal SCAN, connects the data line 102 to a first node n1, and supplies the data voltage Vdata to the first node n1. The first switch TFT M1 includes a gate electrode connected to a first gate line 1041 to which the scan signal SCAN is applied, a first electrode connected to the data line 102, and a second electrode connected to the first node n1. The gate electrode of the driving element DT, the first electrode of the capacitor Cst, and the second electrode of the first switch TFT M1 are connected to the first node n1.

The second switch TFT M2 is turned on in response to the sensing signal SENSE and supplies the reference voltages VPRES and VPRER to the second node n2. The second switch TFT M2 includes a gate electrode connected to a second gate line 1042 to which the sensing signal SENSE is applied, a first electrode connected to the second node n2, and a second electrode connected to the sensing line 103 to which the reference voltages VPRES and VPRER are applied. The second electrode of the driving element DT, the second electrode of the capacitor Cst, and the first electrode of the second switch TFT M2 are connected to the second node n2.

The driving element DT drives the light emitting element OLED by supplying a current to the light emitting element OLED according to the gate-source voltage Vgs. The driving element DT includes a gate connected to the first node n1, a first electrode connected to an ELVDD line 105 to which the pixel driving voltage ELVDD is supplied, and a second electrode connected to the second node n2.

The capacitor Cst is connected between the first node n1 and the second node n2 and maintains the gate-source voltage Vgs of the driving element DT for one frame period.

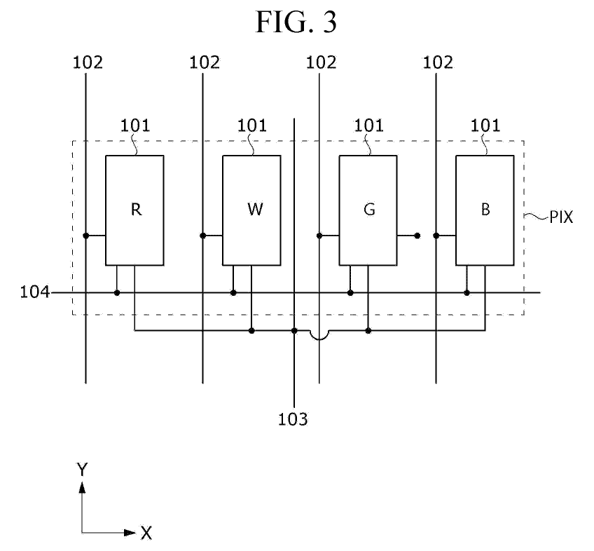

FIG. 3 is a diagram illustrating a connection relationship between a pixel and a sensing line. FIG. 4 is a diagram illustrating an example in which a sensing block of an external compensation circuit is embedded in a driver IC.

Referring to FIGS. 3 and 4, the sensing line 103 can be shared by a plurality of sub-pixels 101. For example, one sensing line 103 can be connected to four adjacent sub-pixels 101 in one pixel line. In FIG. 3, R denotes a red sub-pixel 101, G denotes a green sub-pixel 101, B denotes a blue sub-pixel 101, and W denotes a white sub-pixel 101.

The sensing line 103 can be connected to each of the sub-pixels in a one-to-one manner. However, since a large number of sensing lines 103 are disposed on the pixel array, an aperture ratio of the pixels can decrease. Although the brightness of the light emitting element OLED can be increased as the aperture ratio of the pixels decreases, in this case, the current density of the light emitting element OLED increases, and thus the degradation rate of the light emitting element OLED can increase, and its lifetime can be reduced.

The driver IC (D-IC) of the data driver 110 can include a part of the external compensation circuit. For example, the data driver 110 includes the sensing block 111, a multiplexer 113, a shift register 114, and the ADC 115. The multiplexer 113 sequentially supplies the output voltages of the sensing blocks 111 to one ADC 115 through switch elements SS1 and SS2 connected between the sensing blocks 111 and the ADC 115.

The shift register 114 shifts pulses of an input signal in response to an ADC clock signal ACLK. The switch elements SS1 and SS2 of the multiplexer 113 are sequentially turned on in response to the signal from the shift register 114. The shift register 114 and the ADC 115 share the ADC clock signal ACLK and are synchronized.

The data voltage Vdata for sensing is applied to the gate electrode of the driving element DT after the normal driving mode, and is classified into a first sensing data voltage Vdata applied to sensing target sub-pixels 101 and a second sensing data voltage applied to non-sensing target sub-pixels 101. The non-sensing target sub-pixels 101 refer to sub-pixels that are not sensed when the sensing target sub-pixels 101 are being sensed. Since the electrical characteristics of all sub-pixels are sensed, the non-sensing target sub-pixels 101 are also sequentially selected as sensing target sub-pixels and sensed.

By sensing the anode voltage of the light emitting element OLED, i.e., the voltage of the second node n2, which is generated by a current flowing through the light emitting element OLED via the driving element DT, a degradation level of the driving element DT in the corresponding sub-pixel can be determined. When sensing the electrical characteristics of the driving element DT, it is preferable to control the light emitting element OLED to be in an off state by lowering the reference voltage applied to the second node n2 or raising the low potential power voltage ELVSS such that degradation of the light emitting element OLED is not reflected in the sensing result of the driving element DT.

When the driving element DT degrades, its electrical characteristics (mobility, threshold voltage, and the like) change, causing the current of the light emitting element OLED to change, which makes it difficult to determine the degradation of the light emitting element OLED. This is because the change in the current of the light emitting element OLED caused by the degradation of the driving element DT reduces the accuracy when sensing the degradation of the light emitting element OLED.

In order to block the influence of the driving element DT when sensing the degradation of the light emitting element OLED, the first sensing data voltage used for sensing the degradation of the light emitting element OLED can be set to a voltage level lower than the reference voltage such that the driving element DT is turned off. The second sensing data voltage can be set higher than the reference voltage such that the driving element DT is turned on. The first sensing data voltage can be set to a black gray level voltage, and the second sensing data voltage can be set to a white gray level voltage. The sensing block 111 senses the current or voltage from the second node n2 of the sensing target sub-pixel to which the first sensing data voltage is applied. Since the first sensing data voltage is sequentially applied to all the sub-pixels 101, and the sub-pixels 101 are sensed in synchronization therewith, the light emitting element OLED in each of the sub-pixels 101 can be sensed even if the sensing line is shared by a plurality of sub-pixels 101 as illustrated in FIGS. 3 and 4.

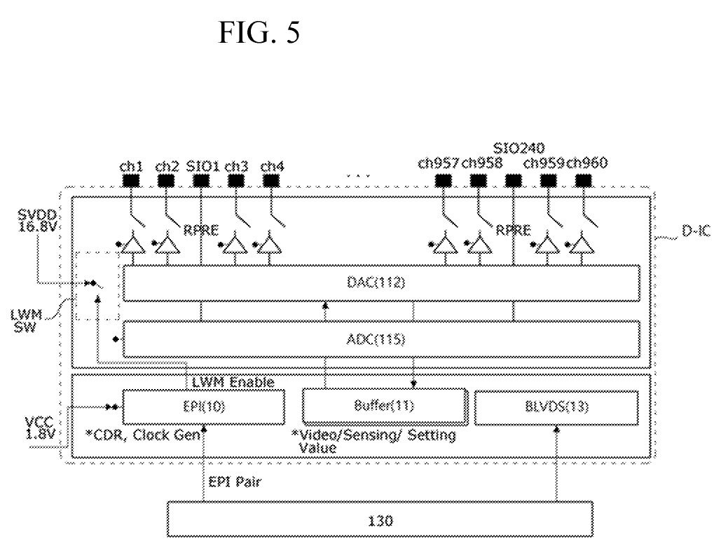

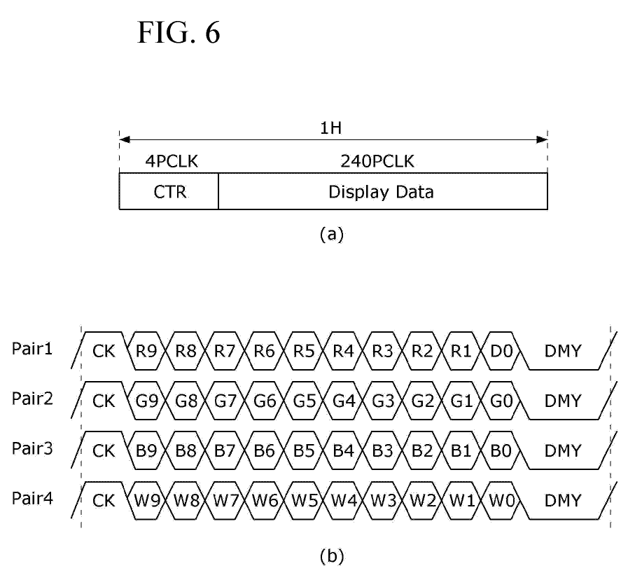

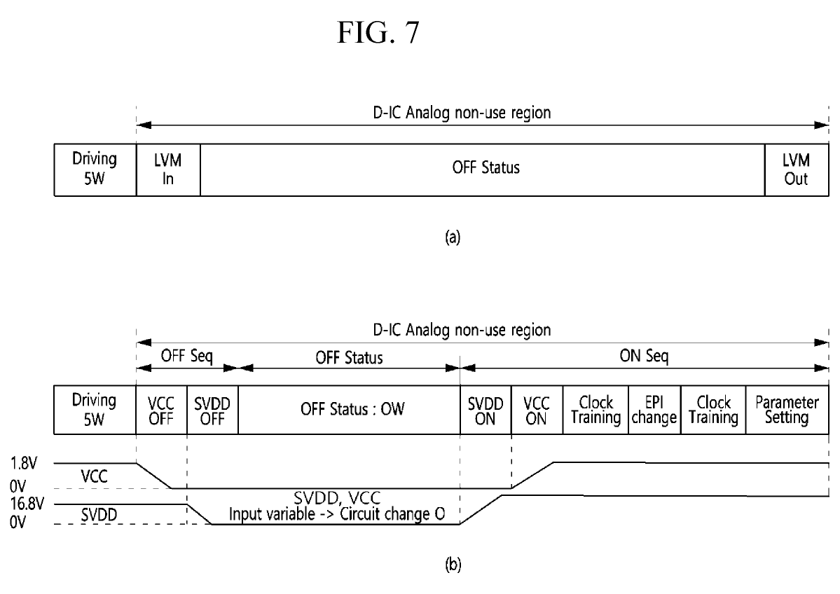

FIG. 5 is a diagram illustrating an example of dividing a driver IC into a first region and a second region according to an embodiment of the present disclosure, FIG. 6 is a diagram illustrating an EPI CTR (control packet) according to an embodiment of the present disclosure, and FIG. 7 is a diagram illustrating transitioning between a normal driving mode and a low power mode according to an embodiment of the present disclosure.

For example, FIG. 5 is a diagram illustrating an example of dividing a driver IC into a first region and a second region according to an embodiment of the present disclosure, FIG. 6 is a diagram illustrating an EPI CTR (control packet) (e.g., external pixel interface control) according to an embodiment of the present disclosure, and FIG. 7 is a diagram illustrating transitioning between a normal driving mode and a low power mode according to an embodiment of the present disclosure.

Referring to FIG. 5, an internal structure of the D-IC according to an embodiment of the present disclosure is illustrated.

At least one component can be mounted in the D-IC. The D-IC can include a first region where components driven by a first voltage provided from an internal power source of the D-IC are mounted, and a second region where components driven by a second voltage provided from the internal power source of the D-IC are mounted.

The first voltage can be an SVDD voltage and can be approximately 16.8 V. The second voltage can be a VCC voltage and can be approximately 1.8 V. For example, the first voltage and the second voltage can be constant voltages provided through a power management integrated circuit (PMIC).

For example, an internal logic operation of the second region where components driven by the second voltage are mounted can be performed based on VCC, and analog processing of the first region where components driven by the first voltage are mounted can be performed based on SVDD. SVDD can be the highest voltage.

The first region can be interpreted as an analog region. The DAC 112, the ADC 115, amplifiers, and the like can be disposed in the analog region. Since the DAC 112 and the ADC 115 disposed in the analog region are the same as described with reference to FIG. 4, a detailed description thereof will be omitted or may be briefly provided.

The first region can include a low power mode switch (LWM SW). The low power mode switch (LWM SW) can be disposed between the internal power source of the D-IC and the components disposed in the first region, and can operate to provide or cut off the first voltage provided from the internal power source of the D-IC to the components disposed in the first region.

The low power mode switch (LWM SW) can be controlled by a cutoff control signal provided through an EPI 10 under the control of the timing controller 130.

The low power mode switch (LWM SW) can operate based on the normal driving mode or the low power mode. For example, in the normal driving mode, the timing controller 130 may not provide the cutoff control signal to the low power mode switch (LWM SW), thereby allowing the first voltage provided from the internal power source of the D-IC to be supplied to the components disposed in the first region.

In contrast, in the low power mode, the timing controller 130 can provide the cutoff control signal to the low power mode switch (LWM SW), thereby cutting off the first voltage provided from the internal power source of the D-IC so that it is not provided to the components disposed in the first region.

Although FIG. 5 illustrates one low power mode switch (LWM SW), the present disclosure is not limited thereto, and the low power mode switch (LWM SW) can be disposed corresponding to each of the components disposed in the first region.

The second region can be interpreted as a digital region. The EPI 10, a buffer 11, and a bus low voltage differential signaling (BLVDS) 13 (e.g., BLVDS unit/circuitry) can be disposed in the digital region. The EPI 10 and the BLVDS 13 are electrically connected to the timing controller and can be driven by receiving various data from the timing controller 130.

In the low power mode, the timing controller 130 can cut off the second voltage provided to the BLVDS 13 among the components disposed in the second region, and can provide the second voltage to the remaining components.

As described above, when a transition occurs from the normal driving mode to the low power mode, the timing controller 130 can cut off the first voltage supplied to the components disposed in the first region.

Simultaneously, when a transition occurs from the normal driving mode to the low power mode, the timing controller 130 can cut off the second voltage provided to the BLVDS 13 among the components disposed in the second region, while maintaining the second voltage supplied to the remaining components, thereby minimizing or reducing a mode transition time and reducing power consumption.

However, the present disclosure is not limited thereto, and when a transition occurs from the normal driving mode to the low power mode, the timing controller 130 can provide a voltage lower than the second voltage to the remaining components in the second region excluding the BLVDS 13, thereby enabling operation at low power and reducing power consumption.

As described above, in the low power mode, the timing controller 130 can cut off or turn off only the second voltage provided to the BLVDS 13 while maintaining a clock, the EPI 10, the buffer 11, and parameters, thereby minimizing or reducing a mode transition time when switching from the normal driving mode to the low power mode or from the low power mode to the normal driving mode.

In addition, the timing controller 130 can cut off the second voltage provided to the BLVDS 13 and change a timing point of a transmit period to further reduce power consumption during high-speed driving or variable refresh rate (VRR) driving. A detailed description thereof will be given later.

In the low power mode, the timing controller 130 can transmit a pin signal or an EPI CTR (control packet) to the EPI 10. The EPI CTR includes various information about the low power mode. The various information can include the cutoff control signal capable of controlling the low power mode switch (LWM SW).

As illustrated in (a) of FIG. 6, an EPI data format can include CTR and display data (or pixel data). For example, when the display panel has 960 channels (Ch) and 4 sub-pixels × 240, the EPI data format can store information for the CTR in 4 PCLKs and information for the display data (or pixel data) in 240 PCLKs, within transmission data during 1H, and transmit the stored information.

In a 4-pair configuration, one PCLK can be configured as shown in (b) of FIG. 6, and a red sub-pixel can be transmitted through Pair 1, a green sub-pixel through Pair 2, a blue sub-pixel through Pair 3, and a white sub-pixel through Pair 4, all synchronized with a clock signal.

Referring to (a) of FIG. 7, when a transition occurs from the normal driving mode to the low power mode, the timing controller 130 can cut off the first voltage supplied to the components disposed in the first region during a D-IC analog non-use period, and can cut off only the second voltage provided to the BLVDS 13 among the components disposed in the second region while maintaining the remaining components such as the clock, EPI, buffer, and parameters, thereby maximizing or increasing an off state, which is a period in which power consumption can be minimized or reduced.

Herein, the D-IC analog non-use region or the D-IC analog non-use period can be defined as a period in which the first voltage to the analog region of the D-IC is cut off, so that the components disposed in the analog region are in an off state.

As illustrated in (b) of FIG. 7, conventionally, in order to enter an off state, which is a period in which power consumption can be minimized or reduced during the D-IC analog non-use period, an Off sequence is generated before switching to the off state, and an On sequence is generated to exit the off state. Therefore, the off state, which is a period in which power consumption can be actually minimized or reduced, was inevitably short.

In contrast, since the timing controller 130 according to an embodiment of the present disclosure can eliminate both the Off sequence and the On sequence during the D-IC analog non-use period, it can not only minimize or reduce the mode transition from the low power mode to the normal driving mode or from the normal driving mode to the low power mode, but also maximize or increase the off state, which is a period during which power consumption can be minimized or reduced.

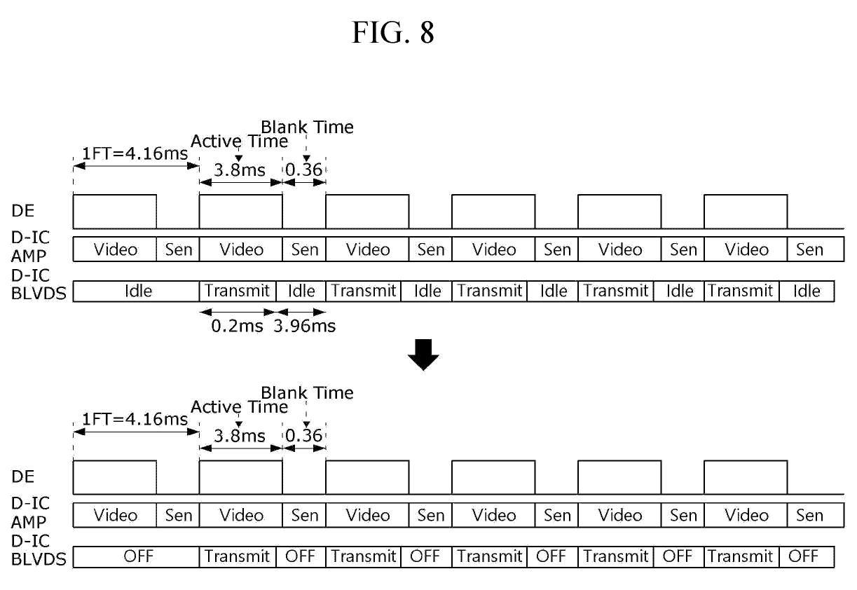

FIG. 8 is a diagram illustrating an operation of a low power mode according to an embodiment of the present disclosure.

Referring to FIG. 8, one frame period (1Frame) can include a video period (Video Time) and a blank period (Blank Time). The blank period (Blank Time) can include a sensing period (Sensing Time).

Herein, the video period (Video Time) can be interpreted as an active period (Active Time), and the sensing period (Sensing Time) can be interpreted as a step of extracting the mobility characteristics of a driving TFT, which is the driving element DT, by applying a specific voltage to the pixel.

The video period (Video Time) can be a period involving several steps: input data received from a set (SET) is processed for image, afterimage, and compensation by the timing controller (TCON) 130 and transmitted to the D-IC through the EPI in accordance with a gate timing of the display panel 100; the transmitted data is converted into a voltage through the internal DAC 112 of the D-IC and transmitted to the driving TFT, which is the driving element DT of the display panel; and the TFT, which is the driving element DT, causes the OLED to emit light by supplying a current corresponding to the voltage for one frame period.

The blank period (Blank Time) can be the remaining period in one frame (1Frame) excluding the video period. The blank period (Blank Time) can be referred to as a vertical blank interval. During the blank period (Blank Time), there is no data enable signal DE and no pixel data of the input image received by the timing controller 130, and there is no pixel data transmitted to the amplifier of the D-IC.

The sensing period (Sensing Time) can be a period during which a current is applied to the driving TFT, which is the driving element DT corresponding to one line of the display panel 100, a reference line (Ref Line) connected to the D-IC is charged by the flowing current, and then the current is converted into digital data (ADC DATA) through the ADC 115 within the D-IC.

The transmit period (Transmit Time) can be a period during which the converted digital data (ADC DATA) is transmitted to the timing controller (TCON) 130 through the BLVDS 13.

After the transmit period (Transmit Time), the timing controller (TCON) 130 can generate a correction value for making the current flowing through the TFT, which is the driving element DT within the display panel, uniform based on the received digital data (ADC DATA), and can finally transmit video data by adding correction data when outputting the video data.

One frame period 1FT illustrated in FIG. 8 is shown based on 240 Hz high-speed driving. The one frame period 1FT can be 4.16 ms, the active period (Active Time), which is the video period (Video Time) of the D-IC amplifier, can be 3.8 ms, the blank period (Blank Time) of the D-IC amplifier can be 0.36 ms, and the sensing period (Sensing Time) of the D-IC amplifier can be set to 0.32 ms. In addition, the transmit period (Transmit Time) of the D-IC BLVDS 13 can be 0.2 ms, and an idle period can be set to 3.96 ms.

During 240 Hz high-speed driving, since the blank period (Blank Time) of the D-IC amplifier (Amp) is relatively insufficient, there can be no time to turn off the BLVDS 13 of the D-IC. However, the timing controller 130 can analyze that transmission to the BLVDS 13 in the D-IC occurs at a predetermined specific time, and based on the analysis result, can control the second voltage VCC provided to the BLVDS 13 to be cut off during the D-IC analog non-use period.

The timing controller 130 can receive the pixel data of the input image synchronized with the data enable signal DE during the active period (Active Time), and can transmit the pixel data to the D-IC amplifier.

The timing controller 130 can cut off the second voltage VCC provided to the BLVDS 13 of the D-IC after the transmit period (Transmit Time), which is synchronized with the timing point of the video period (Video Time). For example, the timing controller 130 can control the second voltage VCC provided to the BLVDS 13 to be cut off during the D-IC analog non-use period, thereby reducing power consumption.

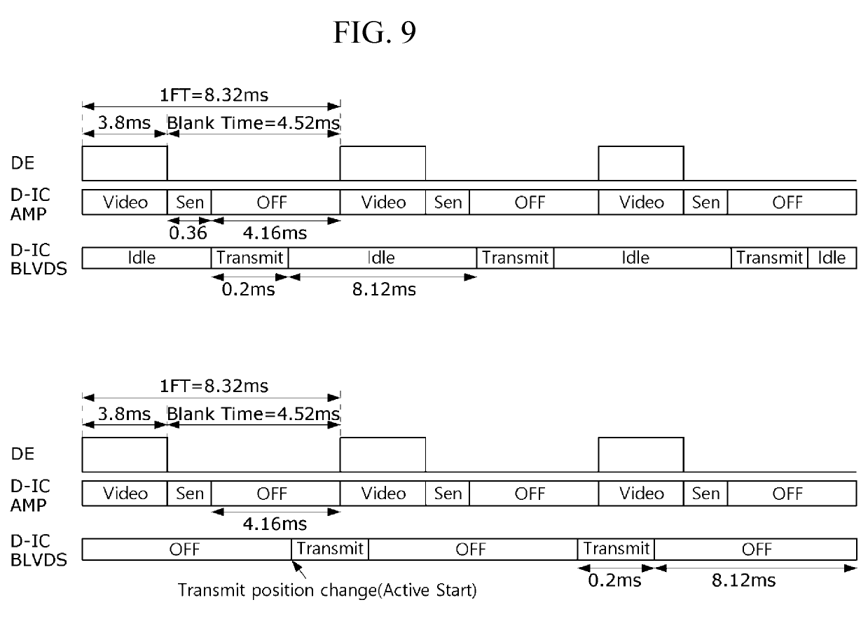

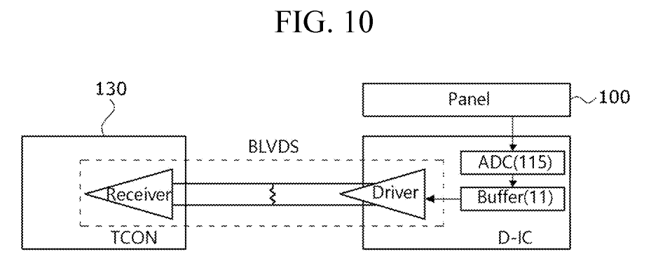

FIG. 9 is a diagram illustrating an operation of a low power mode according to another embodiment of the present disclosure. FIG. 10 is a diagram illustrating a BLVDS according to another embodiment of the present disclosure.

Referring to FIG. 9, the timing controller 130 can analyze the video period (Video Time) and the blank period (Blank Time) within one frame period (1 Frame Time, 1FT), and if it is determined based on the analysis result that the driving is high-speed driving or variable refresh rate (VRR) driving, the timing controller 130 can transition the normal driving mode to the low power mode. Herein, the video period (Video Time) can be interpreted as a pixel driving period.

The one frame period (1 Frame Time, 1FT) can include the video period (Video Time) of the D-IC amplifier and the blank period (Blank Time) of the D-IC amplifier. The blank period (Blank Time) of the D-IC amplifier can include the sensing period (Sensing Time) of the D-IC amplifier and the off period (Off Time) of the D-IC amplifier.

The one frame period (1 Frame Time, 1FT) illustrated in FIG. 9 is shown based on 120 Hz driving. Although the active period (Active Time) of the D-IC amplifier is the same as at 240 Hz, the blank period (Blank Time) of the D-IC amplifier within one frame can increase, so that an idle period of the D-IC amplifier can occur.

For example, the one frame period (1 Frame Time, 1FT) can be 8.32 ms, the active period (Active Time) of the D-IC amplifier, which is the video period of the D-IC amplifier, can be 3.8 ms, the blank period (Blank Time) of the D-IC amplifier can be 4.52 ms, and the sensing period (Sensing Time) of the D-IC amplifier can be set to 0.36 ms. In addition, the transmit period (Transmit Time) of the D-IC BLVDS 13 can be 0.2 ms, and the idle period of the D-IC BLVDS 13 can be set to 8.12 ms.

The timing controller 130 can set an off period (OFF Time) of the D-IC BLVDS 13 to minimize or reduce power consumption according to real-time frequency variation during VRR driving. During VRR driving, the timing controller 130 can need to optimize the off period (OFF Time) according to frequency, as the non-use period of the D-IC and the timing controller (TCON) 130 varies.

The timing controller 130 can change a timing point of the transmit period (Transmit Time) to secure the maximum off period (OFF Time) during low-frequency operation due to VRR.

The timing controller 130 can change a timing point of the transmit period (Transmit Time) and can set the transmit period (Transmit Time) not to overlap with the sensing period of the D-IC amplifier. This is because data stored in the buffer needs to be transmitted when the ADC operation is completed.

During the off period (OFF Time) of the D-IC BLVDS 13, a transceiver of the timing controller 130 or the D-IC BLVDS 13 can be turned off. For example, referring to FIG. 10, the D-IC BLVDS 13 includes a transmitter (Driver) and a receiver (Receiver), and each of the transmitter (Driver) and the receiver (Receiver) can include a power switch capable of On/Off control to transmit or cut off the second voltage VCC. The power switch can be controlled through a signal received via the EPI control packet under the control of the timing controller 130.

As described above, under a 240 Hz condition in which there is no idle period (or delay period) between the sensing period (Sensing Time) of the D-IC amplifier and the video period (Video Time) of the D-IC amplifier, the timing controller 130 can set a timing point of the transmit period (Transmit Time) after the sensing period (Sensing Time) of the D-IC amplifier.

In contrast, under a low refresh rate such as 120 Hz in which there is an idle period (or delay period) of the D-IC amplifier between the sensing period (Sensing Time) of the D-IC amplifier and the video period (Video Time) of the D-IC amplifier, the timing controller 130 can set a timing point of the transmit period (Transmit Time) after the video period (Video Time) by changing a timing point or position of the transmit period (Transmit Time).

In addition, the timing controller 130 can secure a period during which power consumption can be minimized or reduced, by turning off the BLVDS 13 of the D-IC except during the transmit period.

In addition, the timing controller 130 can set the off period (OFF Time) to vary in real time according to the vertical blank period (V-Blank Time) of the D-IC amplifier during VRR driving.

Furthermore, the timing controller 130 can change a timing point of the transmit period (Transmit Time) according to a driving frequency during VRR driving, so that the transmit period (Transmit Time) can operate within the video period (Video Time), thereby securing the maximum off period (OFF Time).

For example, the display device according to one or more embodiments the present disclosure can be applied to mobile devices, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, e-books, portable multimedia players (PMPs), personal digital assistants (PDAs), MP3 players, mobile medical devices, desktop personal computers (PCs)s, laptop PCs, netbook computers, workstations, navigation devices, vehicle display devices, theater display devices, televisions, wallpaper devices, signage devices, gaming devices, laptops, monitors, cameras, camcorders, household appliances, and the like.

The foregoing description of the problems to be solved, the means for solving such problems, and the effects thereof is not intended to define the essential features of the claims, and the scope of the claims shall not be limited by the matters described in the specification.

Accordingly, the embodiments disclosed herein are to be considered descriptive and not restrictive of the technical idea of the present disclosure, and the scope of the technical idea of the present disclosure is not limited by these embodiments. Accordingly, the above-described embodiments should be understood to be examples and not limiting in any aspect. The scope of the present disclosure should be construed by the appended claims, and all technical ideas within the scope of their equivalents should be construed as being included in the scope of the present disclosure.

### [LIST OF REFERENCE NUMBERS]

100: Display panel

110: Data driver

120: Gate driver

130: Timing controller

What is claimed is:

1. An electroluminescent display device comprising:
a display panel in which data lines, sensing lines, and pixels are disposed in a matrix configuration;
a data driver including a driver integrated circuit (IC) configured to supply a data voltage to the data lines; and
a timing controller configured to receive pixel data of an input image and a data enable signal synchronized with the pixel data, the timing controller configured to transmit the pixel data to the data driver,
wherein the driver IC includes a first region and a second region,
wherein, in the first region, components driven by a first voltage supplied through an internal power source of the driver IC are mounted, and in the second region, components driven by a second voltage, different from the first voltage and supplied through the internal power source of the driver IC, are mounted,
wherein, in the first region, a low power mode switch is disposed between the internal power source and the components disposed in the first region, and
wherein the low power mode switch is configured to operate, under control of the timing controller, to provide or cut off the first voltage to the components disposed in the first region.

2. The electroluminescent display device of claim 1, wherein the electroluminescent display device operates in a normal driving mode for displaying the input image on a screen, and a low power mode for driving with low power, and
wherein the timing controller analyzes, during one frame period, a video period during which the pixel data of the input image is written to the pixels, and a blank period excluding the video period.

3. The electroluminescent display device of claim 2, wherein the timing controller transitions from the normal driving mode to the low power mode when it is determined, based on an analysis result, that a high-speed driving or a variable refresh rate (VRR) driving is being performed.

4. The electroluminescent display device of claim 2, wherein the components driven by the second voltage include bus low voltage differential signaling (BLVDS).

5. The electroluminescent display device of claim 4, wherein when a transition occurs from the normal driving mode to the low power mode, the timing controller provides a cutoff control signal to the low power mode switch to cut off the first voltage provided to the components disposed in the first region, and cuts off the second voltage provided to the BLVDS.

6. The electroluminescent display device of claim 5, wherein the timing controller transmits the cutoff control signal to the low power mode switch using an external pixel interface (EPI) control packet during the low power mode.

7. The electroluminescent display device of claim 6, wherein digital data outputted from an analog-to-digital converter is configured to be transmitted to the timing controller through the BLVDS during a transmit period.

8. The electroluminescent display device of claim 7, wherein the timing controller synchronizes a timing point of the transmit period with the video period during the low power mode.

9. The electroluminescent display device of claim 7, wherein the blank period includes a sensing period for extracting mobility characteristics of a driving element by applying a specific voltage to a pixel among the pixels.

10. The electroluminescent display device of claim 9, wherein the timing controller controls the transmit period not to overlap with the sensing period.

11. The electroluminescent display device of claim 8, wherein when it is determined that variable refresh rate (VRR) driving is being performed, the timing controller controls the transmit period to operate within the video period by changing the timing point of the transmit period according to a driving frequency.

12. An electroluminescent display device comprising:
a display panel including data lines, sensing lines, and pixels;
a data driver including a driver integrated circuit (IC) configured to supply a data voltage to the data lines; and
a timing controller configured to receive pixel data of an input image and a data enable signal synchronized with the pixel data, and transmit the pixel data to the data driver,
wherein the driver IC includes a first region and a second region,
wherein, in the first region, components driven by a first voltage supplied through an internal power source of the driver IC are disposed,
wherein, in the second region, components driven by a second voltage, different from the first voltage and supplied through the internal power source of the driver IC, are disposed, and
wherein, in the first region, a low power mode switch is disposed between the internal power source and the components disposed in the first region.

13. The electroluminescent display device of claim 12, wherein the electroluminescent display device operates in one of a normal driving mode for displaying the input image, and a low power mode for driving with low power.

14. The electroluminescent display device of claim 13, wherein the timing controller analyzes, during one frame period, a video period during which the pixel data of the input image is written to the pixels, and a blank period excluding the video period.

15. The electroluminescent display device of claim 13, wherein the timing controller transitions from the normal driving mode to the low power mode when it is determined, based on an analysis result, that a high-speed driving or a variable refresh rate (VRR) driving is being performed.

16. The electroluminescent display device of claim 14, wherein the components driven by the second voltage include bus low voltage differential signaling (BLVDS).

17. The electroluminescent display device of claim 16, wherein when a transition occurs from the normal driving mode to the low power mode, the timing controller provides a cutoff control signal to the low power mode switch to cut off the first voltage provided to the components disposed in the first region, and cuts off the second voltage provided to the BLVDS.

18. The electroluminescent display device of claim 16, wherein digital data outputted from an analog-to-digital converter is configured to be transmitted to the timing controller through the BLVDS during a transmit period, and
wherein the timing controller synchronizes a timing point of the transmit period with the video period during the low power mode.

19. The electroluminescent display device of claim 18, wherein the blank period includes a sensing period for extracting mobility characteristics of a driving element by applying a specific voltage to a pixel among the pixels.

20. The electroluminescent display device of claim 19, wherein the timing controller controls the transmit period not to overlap with the sensing period.
